(19) United States
(12) Patent Application Publication
(10) Pub. No.: US 2017/0092082 A1
(43) Pub. Date: Mar. 30, 2017

(54) SERVER DEVICES WITH INTEGRATED PATHWAYS OF ERROR INDICATOR LIGHTS AND METHODS THEREOF

(71) Applicant: NetApp, Inc., Sunnyvale, CA (US)

(72) Inventors: Allen Tracht, Pittsburgh, PA (US); Stuart Lovett, Coraopolis, PA (US); Brad Reger, Dublin, CA (US); Mark Insley, Sunnyvale, CA (US)

(21) Appl. No.: 14/865,800

(22) Filed: Sep. 25, 2015

(51) Int. Cl. G08B 5/36

(52) U.S. Cl. CPC G08B 5/36

(57) ABSTRACT

A device, method and non-transitory computer readable medium that provides an error indicator light pathway includes identifying an error with one of a plurality of field replaceable units in the server device. A pathway comprising two or more of a plurality of error indicator lights located at two or more of within a chassis of the server device, on an outer service side of the chassis, or on another outer side of the chassis to the identified error with the one of the plurality of field replaceable units is determined. Illumination of the determined pathway of the two or more of the plurality of error indicator lights is initiated.

### FIELD

This technology generally relates to devices and methods for providing a warning indication and, more particularly, server devices with integrated pathways of indicator error lights and methods thereof.

### BACKGROUND

Many large scale computing environments need to utilize numerous servers and other computing devices each which have a plurality of different field replaceable units. Over time these replaceable electronics units within these servers and other computing devices may experience errors requiring physical service or replacement.

Unfortunately, in large scale computing environments the location and identification of the particular field replaceable unit requiring physical service or replacement can be time consuming and prone to human error. As result, the outage resulting from the error may unnecessarily be extended in duration or scope because of the time required and/or the potential human error in correctly identifying and locating the replaceable field replaceable unit with the error.

### BRIEF DESCRIPTION OF THE DRAWINGS

FIG. 1 is a block diagram of an example of a server device with integrated pathways of indicator error lights;

FIG. 2 is a flow chart of an example of a method for providing an error indicator light pathway;

FIG. 3 is a diagram of an example of a plurality of server devices with one of the indicator error lights of the pathway along a side of a chassis of one of the server devices illuminated;

FIG. 4 is a diagram of the example of the plurality of server devices with another one of the indicator error lights of the pathway along an outer service side of the chassis of the one of the server devices illuminated; and

FIG. 5 is a diagram of the example of the plurality of server devices with yet another one of the indicator error lights of the pathway inside the chassis of the one of the server devices illuminated.

### DETAILED DESCRIPTION

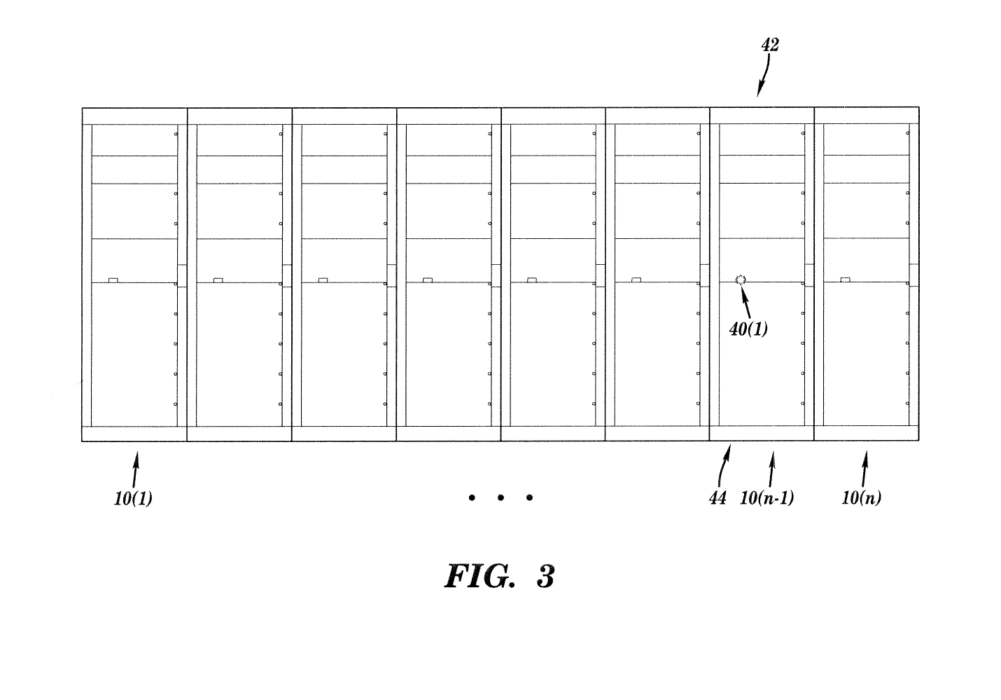

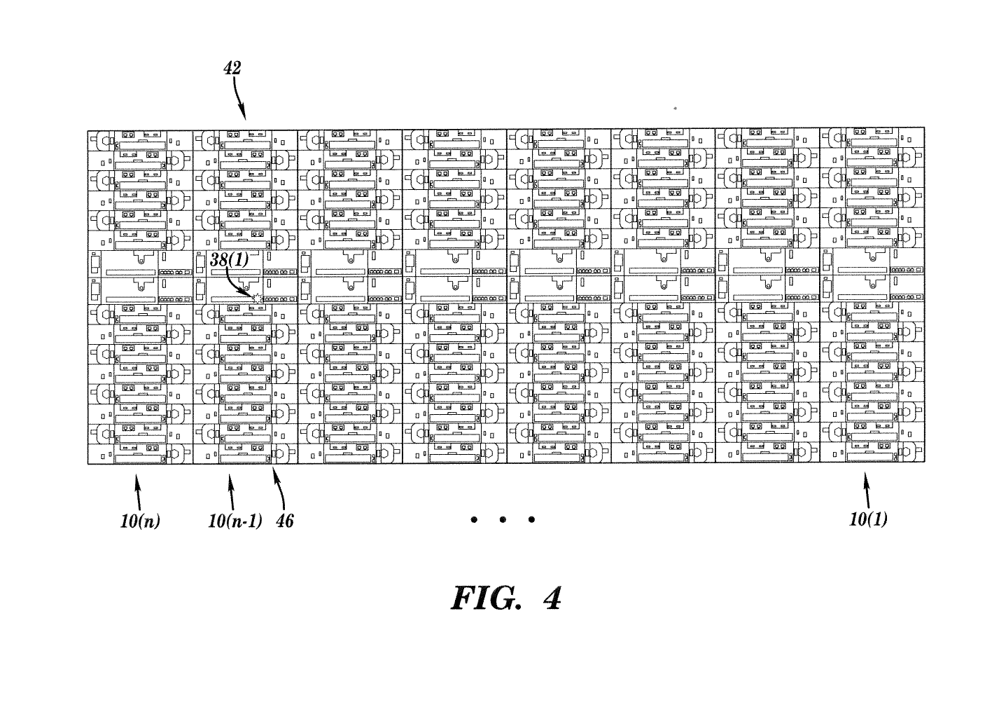

An example of a plurality of server devices 10(1)-10(n) which each have integrated pathways of indicator error lights is illustrated in FIG. 3-4, although the integrated pathways of indicator lights can be in other types and/or numbers of other servers or other computing devices in other configurations. This technology provides a number of advantages including devices, methods, and non-transitory computer readable media that facilitate servicing of field replaceable units with integrated pathways of indicator lights which can be illuminated when an error is detected.

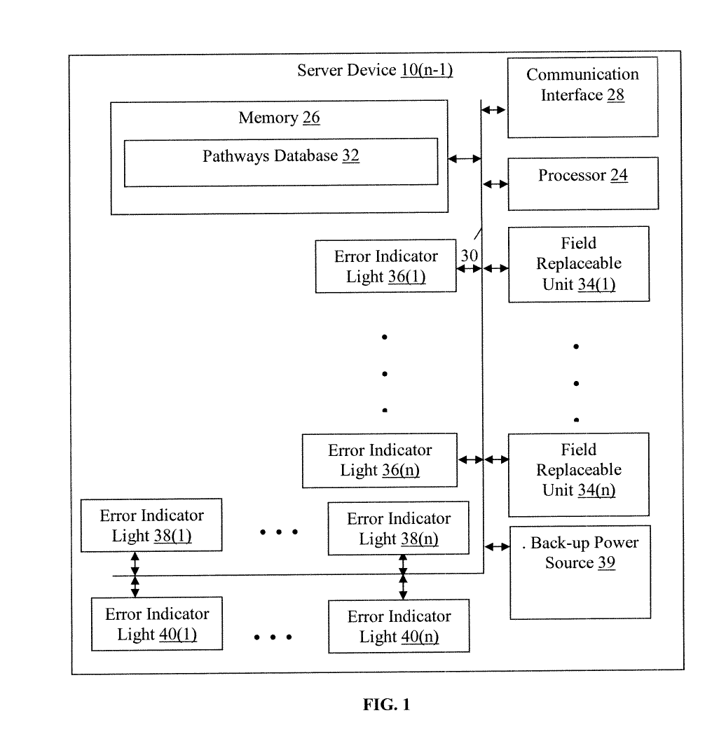

Referring to FIG. 1, a block diagram of an example of the server device 10(n-1) is illustrated. In this particular example, the other server devices 10(1)-10(n-2) and 10(n) are the same in structure and operation as the server device 10(n-1) and thus will not be described here, although each could have other types and/or numbers of other systems, devices, components, and/or other elements in other configurations and/or could perform other types and/or numbers of other functions and/or operations. The server device 10(n-1) in this example includes a processor 24, a memory 26, a communication interface 28, field replaceable units 34(1)-34(n), error indicator lights 36(1)-36(n), 38(1)-38(n), and 40(1)-40(n), an optional back-up power source 39 coupled together by a bus 30 or other communication link, although the server device 10(n-1) could comprise other types and/or numbers of systems, devices, components, and/or other elements in other configurations.

The processor 24 of the server device 10(n-1) executes a program of stored instructions for one or more aspects of the present invention, as described and illustrated by way of the embodiments herein, although the processor 24 could execute other numbers and types of programmed instructions. The processor 24 in the server device 10(n-1) may include one or more central processing units or general purpose processors with one or more processing cores, for example.

The memory 26 of the server device 10(n-1) may include any of various forms of read only memory (ROM), random access memory (RAM), Flash memory, non-volatile, or volatile memory, or the like, or a combination of such devices for example. The memory 26 in this example includes an optional pathways database 32 which may have stored data on which of the which of the error indicator lights 36(1)-36(n), 38(1)-38(n), 40(1)-40(n), and/or other error indicator lights need to be illuminated for pathways to one or more of the field replaceable units 34(1)-34(n), although other manners for determining the pathways can be used. By way of example only, the processor 24 may executed programmed instructions in memory 26 to identify when either one of the field replaceable units 34(1)-34(n) either does not have a stored pathway or is a new field replaceable unit and then can generate a pathway of which of the error indicator lights 36(1)-36(n), 38(1)-38(n), 40(1)-40(n), and/or other error indicator lights need to be illuminated. In this example, the generated pathway needs to be determined to provide a pathway from at least inside the chassis 42 adjacent the one of the field replaceable units 34(1)-34(n), to an outer service side 46 of the chassis 42, and to another outer side 44 of the chassis 42 which would provide a noticeable first visual indication of a need for service, although other types of pathways with other requirements could be generated. Additionally, the memory 26 may comprise other types and/or numbers of other modules, sets of programmed instructions, and/or data.

The communication interface 28 of the server device 10(n-1) in this example can include one or more network interface controllers (NICs) for operatively coupling and communicating between the server device 10(n-1) and the other server devices 10(1)-10(n-2) and 10(n) and/or other servers, computing devices, and/or other databases by way of example only.

The field replaceable units 34(1)-34(n) comprise elements of the server device 10(n-1) which may over time require servicing or replacement. The field replaceable units 34(1)-34(n) typically are located inside the chassis 42 and may be accessible via sliding shelves for service.

In this particular example, three sets of indicator lights 36(1)-36(n), 38(1)-38(n), and 40(1)-40(n) are provided as illustrated in FIGS. 1 and 3-5, although other types and/or numbers of error indicator lights may be used to generate a longer pathway to assist with service operations, such as a pathway defined by just two lights or four or more lights by way of example only. Additionally, in this particular example, the indicator lights 36(1)-36(n) may be located inside the chassis 42 of the server device 10(n-1) and each may be positioned adjacent to a corresponding one of the field replaceable units 34(1)-34(n), although the indicator lights 36(1)-36(n) could be in other locations. Additionally, the error indicator lights 38(1)-38(n) may be positioned on an outer service side 46 of the chassis 42 (a back side of the chassis 42 in this example), although the indicator lights 38(1)-38(n) could be in other locations. Further, the error indicator lights 40(1)-40(n) may be positioned on another outer side of the chassis 42 (a front side of the chassis 42 in this example), although the indicator lights 36(1)-36(n) could be in other locations. Each of the indicator lights 36(1)-36(n), 38(1)-38(n), and 40(1)-40(n) may also have the same display property, such as the same color, duration in an on or off state, and/or intensity by way of example only.

An optional back-up power supply 39 may be coupled to the error indicator lights 36(1)-36(n), 38(1)-38(n), 40(1)-40(n), and/or other error indicator lights as well as to other elements in the server device 10(n-1). With the back-up power supply 39, power can be maintained to the illuminated ones of the error indicator lights 36(1)-36(n), 38(1)-38(n), 40(1)-40(n), and/or other error indicator lights to ensure the pathway remains lit during servicing operations.

Although examples of the server devices 10(1)-10(n) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as one or more non-transitory computer readable media having instructions stored thereon for one or more aspects of the present technology, as described and illustrated by way of the examples herein, which when executed by the processor, cause the processor to carry out the steps necessary to implement the methods of this technology, as described and illustrated with the examples herein.

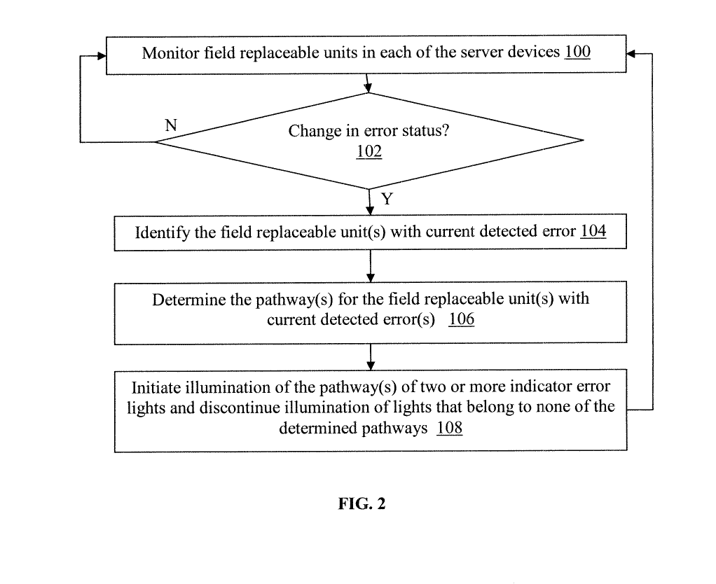

An exemplary method for providing an error indicator light pathway will now be described with reference to FIGS. 1-5. In step 100, each of the server devices 10(1)-10(n) may monitor for an error in one of the field replaceable units 34(1)-34(n), although other approaches for identifying an error, such as a fault or a service issue by way of example only, may be used. In this example, each of the server devices 10(1)-10(n) may poll each of their field replaceable units 34(1)-34(n) to determine status and monitor for errors, although other approaches could be used, such as by interrupts generated by the field replaceable units 34(1)-34(n) when an error is identified or a hybrid approach of polling and interrupts by way of example only.

In step 102 each of the server devices 10(1)-10(n) determines when a change in status of an error or errors has been identified in one or more of their field replaceable units 34(1)-34(n) based on the monitoring, although other approaches for determining when an error has been identified could be used. If in step 102 each of the server devices 10(1)-10(n) determines a change in error status has not been identified, then the No branch is taken to step 100 as described above. If in step 102 each of the server devices 10(1)-10(n) determines a change in error status has been identified, then the Yes branch is taken to step 104.

By way of example only, one or more of the server devices 10(1)-10(n) may determine one of the field replaceable units 34(1)-34(n) has a change in error status because of a new error identified based on the monitoring in step 100. In another example, one or more of the server devices 10(1)-10(n 10(1)-10(n) may determine one of the field replaceable units 34(1)-34(n) has a change in error status because a previously detected error has been cleared. By way of example only, one or more of the server devices 10(n-1) may determine that an error has been cleared: when the completion of the replacement of the one of the field replaceable units 34(1)-34(n) is detected; when the completion of the service operation on the one of the field replaceable units 34(1)-34(n) is detected; when engagement of a “fixed” button or switch is detected; or upon receipt of a transmitted command of the completion of the service operation, although other approaches for determining when the lights of the determined pathway can be turned off may be used.

In step 104, each of the server devices 10(1)-10(n) with an error in one of their field replaceable units 34(1)-34(n) identifies the particular one with an error, although other approaches for obtaining the identification information for the one of the field replaceable units 34(1)-34(n) can be used. In this particular example for ease of discussion, server device 10(n-1) is illustrated as having an error with one of the field replaceable units 34(1)-34(n), although other numbers of the server devices 10(1)-10(n) and/or other numbers of field replaceable units 34(1)-34(n) may at one time have an error.

In step 106, in this particular example the server device 10(n-1) has an error in one of its field replaceable units 34(1)-34(n) determines the pathway for which of the error indicator lights 36(1)-36(n), 38(1)-38(n), and/or 40(1)-40(n) to illuminate, although the server device (n-1) may have errors with other ones of the field replaceable units 34(1)-34(n) and/or one or more of the other server devices 10(1)-10(n-2) and/or 10(n) may have errors with one or more of their field replaceable units 34(1)-34(n). In this particular example, the server device 10(n-1) can determine the pathway of which of the error indicator lights 36(1)-36(n), 38(1)-38(n), 40(1)-40(n), and/or other error indicator lights need to be illuminated from a pathways database 32, although the pathways could be stored in other locations and other approached for determining the pathway can be used. For example, the server device 10(n-1) can generate a pathway of which of the error indicator lights 36(1)-36(n), 38(1)-38(n), 40(1)-40(n), and/or other error indicator lights need to be illuminated. In this example, the generated pathway needs to be determined by the server device 10(n-1) to provide a pathway from at least inside the chassis 42 adjacent the one of the field replaceable units 34(1)-34(n), to an outer service side 46 of the chassis 42, and/or to another outer side 44 of the chassis 42 which would provide a noticeable first visual indication of a need for service, although other types of pathways based on other requirements could be generated.

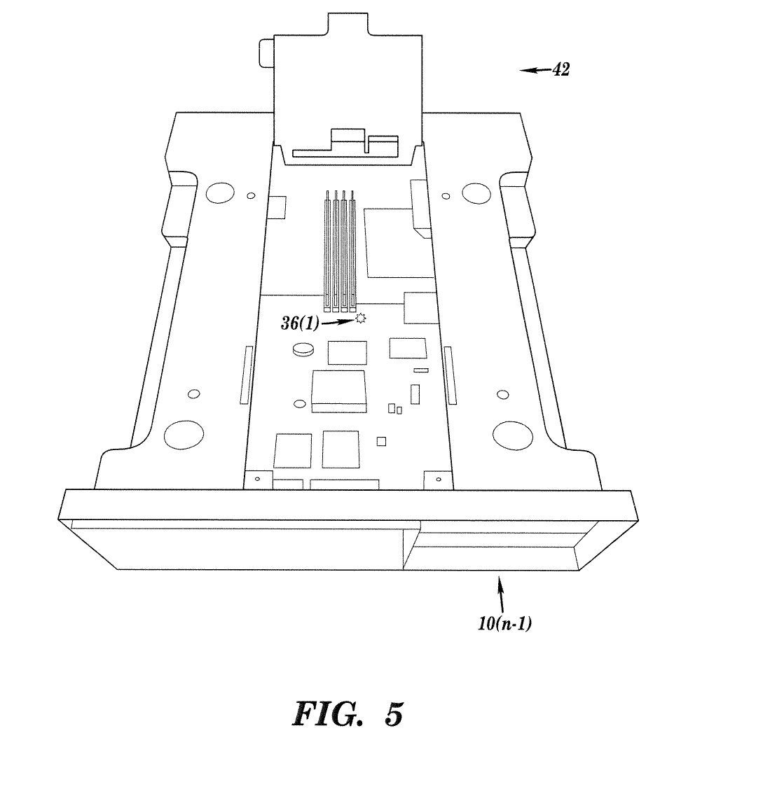

In step 108, in this particular example the server device 10(n-1) transmits signals based on the determined pathway to illuminate designated ones of the error indicator lights 36(1)-36(n), 38(1)-38(n), 40(1)-40(n), and/or other error indicator lights to provide a map for the necessary service operation. During this service operation, the optional backup power supply 39 may be used to continue to illuminate the pathway to aid with the service operation. By way of example only, in FIG. 3 error indicator light 40(1) on a front outer side 44 of the chassis 40 of server device 10(n-1) is illuminated. Additionally, in FIG. 4, error indicator light 38(1) on an outer service side 44 of the chassis 40 of server device 10(n-1) is illuminated. Further, in FIG. 5 error indicator light 36(1) inside of the chassis 40 of server device 10(n-1) is illuminated to provide the pathway, although again other types and/or numbers of lights may be provided. In another example, when multiple errors occur each of the different pathways may be illuminated and they may be illuminated having a different display property, such as color, intensity, and/or duration by way of example only, to assist in distinguishing the different pathways.

Additionally, in step 108 based on the detected change(s) in error status(es) in step 102 one or more of the server device 10(1)-10(n) may have determined pathway(s) which no longer need to be illuminated. Accordingly, when the detected change(s) in error status(es) indicates one or more determined pathways no longer need to be illuminated, one or more of the server devices 10(1)-10(n) may determine which of the designated ones of the error indicator lights 36(1)-36(n), 38(1)-38(n), 40(1)-40(n), and/or other error indicator lights for the determined pathway(s) should be turned off. In another example, if multiple errors were identified and one or more of the designated ones of the error indicator lights 36(1)-36(n), 38(1)-38(n), 40(1)-40(n), and/or other error indicator lights were shared by two or more of the determined pathways, then the one of the server devices 10(1)-10(n) would identify and leave on any of the shared light(s) for any of the determined pathways for which the service operation(s) has/have not been completed, although other approaches can be used. Next, this example of the method may return to step 100 as described earlier.

Accordingly, as illustrated and described by way of the examples herein, this technology provides devices, methods, and non-transitory computer readable media that provide an effective error indicator light pathway to facilitate service operations. With this technology, a service engineer can simply follow the lit pathway to the field replaceable unit that requires attention which accelerates the completion of the service operation and reduces human error. Accordingly, this reduction in errors made by service engineers, leads to less downtime due to mistakes and provides higher confidence that the correct field replaceable unit was serviced.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

1. A computing device comprising:
a plurality of field replaceable units and a plurality of error indicator lights;
a memory containing machine readable medium comprising machine executable code having stored thereon instructions for performing a method for providing an error indicator light pathway;
a processor coupled to the memory, the plurality of field replaceable units and the plurality of error indicator lights, the processor configured to execute the machine executable code to cause the processor to:
identify an error with one of the plurality of field replaceable units in the computing device;
determine a pathway to the one of the plurality of field replaceable units within the chassis with the identified error comprising two or more of the plurality of error indicator lights located:
within a chassis of the computing device; and
at least one of on an outer service side of the chassis or on another outer side of the chassis; and
initiate illumination of the determined pathway of the two or more of the plurality of error indicator lights to the one of the plurality of field replaceable units within the chassis with the identified error.

2. The device as set forth in claim 1 wherein the determine the pathway further comprises additional machine executable code to cause the processor to identify the pathway from a plurality of stored pathways based on the one of the plurality of field replaceable units within the chassis with the identified error.

3. The device as set forth in claim 1 wherein the determine the pathway further comprises additional machine executable code to cause the processor to dynamically generate the pathway comprising the two or more of the plurality of error indicator lights to the identified error with the one of the plurality of field replaceable units based on at least the identified error and location data for each of the plurality of error indicator lights.

4. The device as set forth in claim 1 further comprising additional machine executable code to cause the processor to monitor one or more characteristics of the plurality of field replaceable units in the computing device, wherein the identify the error is based on the monitored one or more characteristics.

5. The device as set forth in claim 1 wherein the plurality of error indicator lights for the determined pathway each have an identical display property for the illumination.

6. The device as set forth in claim 5 wherein the identify the error identifies at least one additional error resulting in an additional determined pathway, the plurality of error indicator lights for the additional determined pathway have a different identical display property from the identical display property for the plurality of error indicator lights for the determined pathway.

7. The device as set forth in claim 1 further comprising a back-up power source coupled to the plurality of error indicator lights configured to maintain illumination of the determined pathway of the two or more of the plurality of error indicator lights during a service operation.

8. A method for providing an error indicator light pathway, the method comprising:
identifying, by a computing device, an error with one of a plurality of field replaceable units in the computing device;
determining, by the computing device, a pathway to the one of the plurality of field replaceable units within the chassis with the identified error comprising two or more of a plurality of error indicator lights located:
within a chassis of the computing device; and
at least one of on an outer service side of the chassis or on another outer side of the chassis; and
initiating, by the computing device, illumination of the determined pathway of the two or more of the plurality of error indicator lights to the one of the plurality of field replaceable units within the chassis with the identified error.

9. The method as set forth in claim 8 wherein the determining the pathway further comprises identifying, by the computing device, the pathway from a plurality of stored pathways based on the identified error with the one of the plurality of field replaceable units.

10. The method as set forth in claim 8 wherein the determining the pathway further comprises dynamically generating, by the server device, the pathway comprising the two or more of the plurality of error indicator lights to the one of the plurality of field replaceable units within the chassis with the identified error based on at least the identified error and location data for each of the plurality of error indicator lights.

11. The method as set forth in claim 8 further comprising monitoring one or more characteristics of the plurality of field replaceable units in the computing device, wherein the identifying the error is based on the monitored one or more characteristics.

12. The method as set forth in claim 8 wherein the plurality of error indicator lights for the determined pathway each have an identical display property for the illumination.

13. The method as set forth in claim 12 wherein the identify the error identifies at least one additional error resulting in an additional determined pathway, the plurality of error indicator lights for the additional determined pathway have a different identical display property from the identical display property for the plurality of error indicator lights for the determined pathway.

14. A non-transitory computer readable medium having stored thereon instructions for performing a method comprising machine executable code which when executed by at least one machine, causes the machine to:
identify an error with one of a plurality of field replaceable units in a computing device;
determine a pathway to the one of the plurality of field replaceable units within the chassis with the identified error comprising two or more of a plurality of error indicator lights located:
within a chassis of the computing device; and
at least one of on an outer service side of the chassis or on another outer side of the chassis; and
initiate illumination of the determined pathway of the two or more of the plurality of error indicator lights to the one of the plurality of field replaceable units within the chassis with the identified error.

15. The medium as set forth in claim 14 wherein the determine the pathway further comprises machine executable code which when executed by at least one machine, causes the machine to identify the pathway from a plurality of stored pathways based on the identified error with the one of the plurality of field replaceable units.

16. The medium as set forth in claim 14 wherein the determine the pathway further comprises machine executable code which when executed by at least one machine, causes the machine to dynamically generate the pathway comprising the two or more of the plurality of error indicator lights to the one of the plurality of field replaceable units within the chassis with the identified error based on at least the identified error and location data for each of the plurality of error indicator lights.

17. The medium as set forth in claim 14 further comprising machine executable code which when executed by at least one machine, causes the machine to monitor one or more characteristics of the plurality of field replaceable units in the computing device, wherein the identify the error is based on the monitored one or more characteristics.

18. The medium as set forth in claim 14 wherein the plurality of error indicator lights for the determined pathway each have an identical display property for the illumination.

19. The medium as set forth in claim 18 wherein the identify the error identifies at least one additional error resulting in an additional determined pathway, the plurality of error indicator lights for the additional determined pathway have a different identical display property from the identical display property for the plurality of error indicator lights for the determined pathway.
